(19) United States
(12) Patent Application Publication
(10) Pub. No.: US 2002/0110050 A1
(43) Pub. Date: Aug. 15, 2002

(54) Interchangeable display timepiece

(76) Inventor: Juan Fernandez, Ridgefield Park, NJ (US)

Correspondence Address: KILPATRICK STOCKTON LLP, 607 14TH STREET, N.W., SUITE 900, WASHINGTON, DC, 20005, US

(21) Appl. No.: 09/781,232

(22) Filed: Feb. 13, 2001

(51) Int. Cl. A44C 5/00; G04B 37/00

(52) U.S. Cl. 368/281

(57) ABSTRACT

A timepiece housing, which contains a horological mechanism, is designed to adopt an interchangeable and transparent cover attached over the lens of the timepiece. According to one embodiment of the present invention, the underside face of this attached cover is designed with a cavity into which a decorative item can be placed. According to another embodiment of the present invention, the lens is designed with a cavity into which a decorative item can be placed. The dial face and the hands of the timepiece are made to a size such that when the transparent cover with the decorative item placed inside the cavity is fitted to the timepiece, the viewing of the dials and hands of the watch is not obstructed by the decorative item. The design provides a convenient means of decorating a timepiece with without the need of dismantling the housing of the watch.

### BACKGROUND OF THE INVENTION

1. Field of the Invention

The present invention relates generally to the field of timepieces, such as a watch or a clock. The present invention farther relates to the styling of timepieces.

2. Description of Related Art

The single most distinctive visual element of any timepiece is its face. It is the face that gives the timepiece its character and personality. The face of a clock or watch sets the tone or the mood. With few exceptions, timepieces are made with a single, permanent face. The only way to change the character or look of the timepiece is to replace the entire watch or clock.

### BRIEF SUMMARY OF THE INVENTION

The preferred embodiments of the present invention utilize an add-on cover, which is attached to the outside face of a timepiece, such as a watch or clock. The add-on cover includes a cavity for holding a decorative item. Such a decorative item may include, but is not limited to: coins, tokens, stones or gems, stamps, photographs, pictures and artwork, printed material, a locket of hair and/or any other items or portions of items that can be inserted into the timepiece (e.g., within a suitable receptacle). The add-on cover is designed so that any decorative item fitting within the cavity of the add-on cover will not affect the view of the hands of the dial face of the timepiece. This invention can thus avoid any chance of damaging or negatively affecting the integrity of the timepiece.

One embodiment of the present invention is drawn to a timepiece. The timepiece has a body made up of a case, a back cover, a dial plate, a lens and a horological mechanism. The horological mechanism is contained within the body between the back cover and the dial plate. A shaft is operatively connected to the horological mechanism and extends in a substantially perpendicular direction to the dial plate. At least one hand is attached to the shaft and extends in a direction substantially parallel to the dial plate. The at least one hand, according to the embodiment, is contained within the body between the dial plate and the lens. The embodiment also includes an add-on cover, which is attachable to the body and which includes a cavity. In another embodiment, the add-on cover includes a bottom face that lies adjacent to the lens when the add-on cover is attached to the case.

In another embodiment, the timepiece includes a securing means for securing the add-on cover to the body. More specifically, in another embodiment, the add-on cover includes a plurality of lugs that are designed to fit into a plurality of channels formed in the case so that when the lugs are locked into the channels the add-on cover is securely attached to the body.

In another embodiment, the hands of the timepiece include a minute hand and an hour hand. According to an embodiment, the minute hand and the hour hand have different shapes so that the two hands can be distinguished from one another. The hands, according to another embodiment, extent beyond the cavity in the timepiece so that the hands can be seen even when there is a decorative item in the cavity.

Another embodiment of the present invention is also drawn to a timepiece. The timepiece has a body made up of a case, a back cover, a dial plate, a lens and a horological mechanism. The horological mechanism is contained within the body between the back cover and the dial plate. A shaft is operatively connected to the horological mechanism and extends in a substantially perpendicular direction to the dial plate. At least one hand is attached to the shaft and extends in a direction substantially parallel to the dial plate. The at least one hand, according to the embodiment, is contained within the body between the dial plate and the lens. According to this embodiment, the lens includes a cavity. The embodiment also includes an add-on cover, which is attachable to the body such that the add-on cover is adjacent to the lens and such that the add-on cover covers the cavity in the lens.

Other features, advantages, and embodiments of the invention are set forth in part in the description that follows, and in part, will be obvious from this description, or may be learned from the practice of the invention.

### BRIEF DESCRIPTION OF THE DRAWINGS

The foregoing and other features and advantages of this invention will become more apparent by reference to the following detailed description of the invention taken in conjunction with the accompanying drawings.

FIG. 1 shows a top isometric view of a timepiece fitted with a transparent add-on cover and embedded with a metal coin.

FIG. 2 shows a side sectional view of a timepiece, a metal coin, and a transparent add-on cover.

FIG. 3 shows an exploded top isometric view of a timepiece fitted with a transparent add-on cover and embedded with a metal coin.

FIG. 4 shows a top isometric view of the transparent add-on cover embedded with a metal coin.

FIG. 5 shows a exploded bottom isometric view of an add-on cover and a metal coin.

FIG. 6 shows a sectional side view of an alternative design of an add-on cover embedded with a metal coin.

FIG. 7 shows a side sectional view of an alternative design of a timepiece fitted with a transparent add-on cover.

FIG. 8 shows a side sectional view of an alternative design of a timepiece fitted with a transparent add-on cover.

### DETAILED DESCRIPTION OF THE PREFERRED EMBODIMENTS OF THE INVENTION

As embodied and broadly described herein, the preferred embodiments of the present invention are directed to a novel timepiece. In particular, preferred embodiments are directed to a timepiece that includes a means by which a decorative item may be attached to the timepiece.

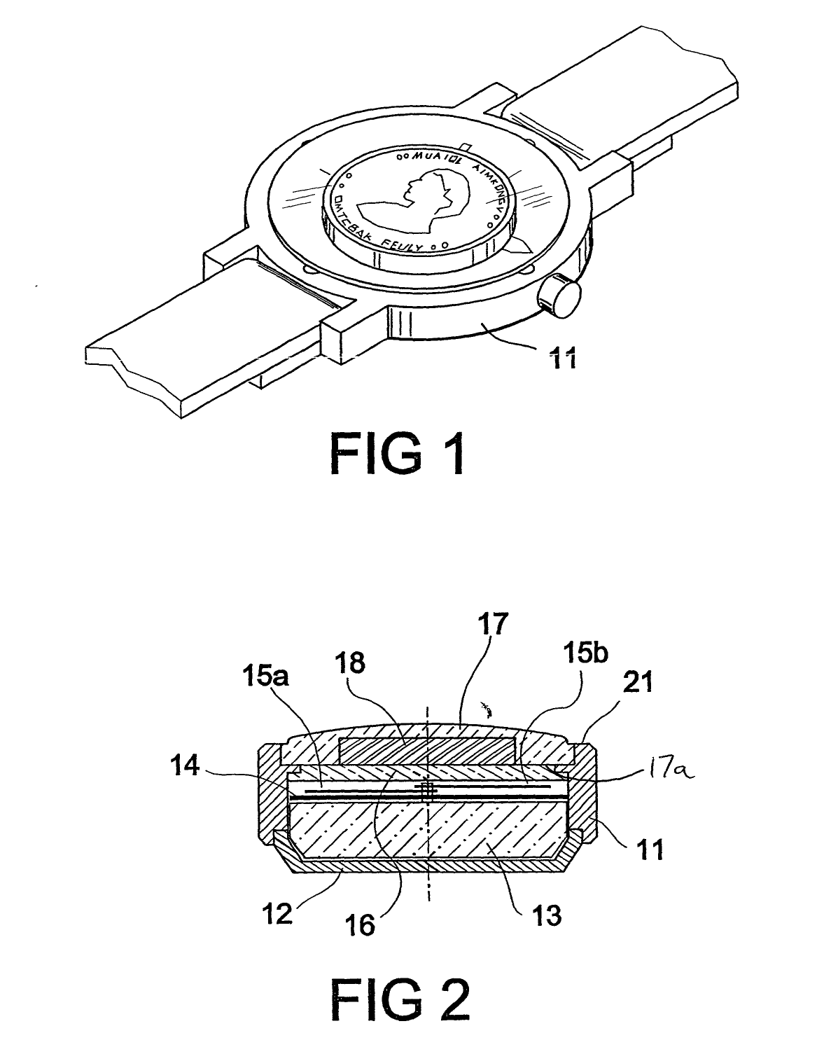

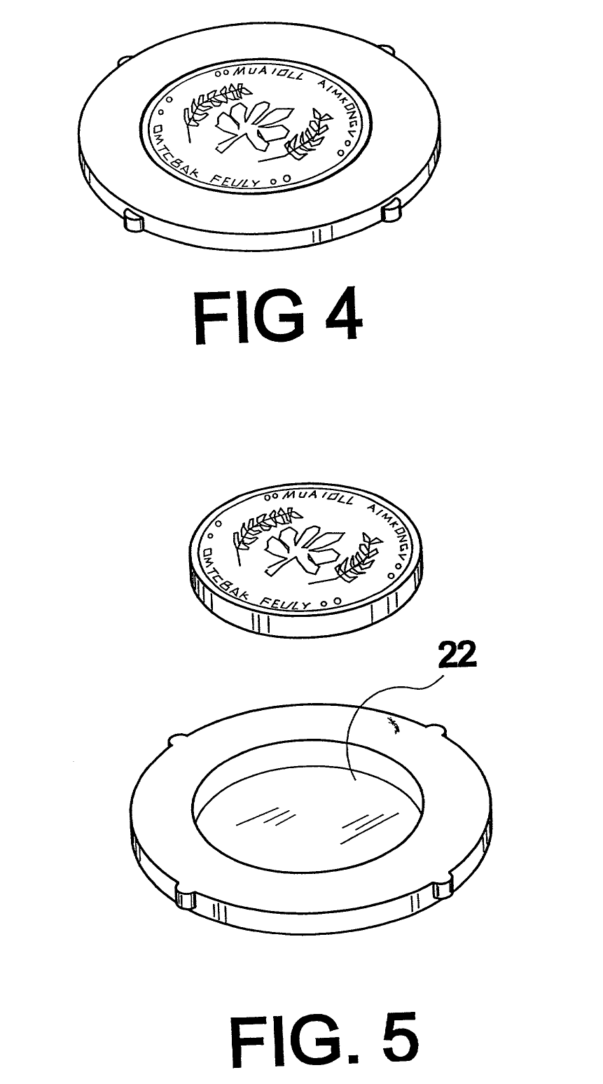

FIGS. 1-7 show various embodiments of the present invention. While the figures use a wristwatch for illustrative purposes, the present invention is directed to timepieces in general and should not be construed to be limited to only wristwatches. A clock, for example, is also contemplated by the invention. In addition, FIGS. 1-7 show a wristwatch with a round face. Once again, it is only for illustrative purposes and should not be construed as limiting the invention to timepieces with round faces. It is contemplated that other face shapes, such as square or rectangular, would work equally well.

FIGS. 1-5, show a timepiece that includes a case 11, a back cover 12, a horological mechanism 13, a dial plate 14, a minute hand 15a, an hour hand 15b, and a lens 16. The timepiece is fitted with an add-on cover 17 having a cavity 22 into which a decorative item 18 is placed. The add-on cover 17 comprises a bottom face 17a in which the cavity 22 is formed. While both a minute hand 15a and an hour hand 15b are shown, it is contemplated that the present invention may include a timepiece with any number of hands. In addition it is contemplated that the decorative item may include any item that can be fitted into the cavity including, but not limited, to a coin, a picture and a locket of hair.

As stated above, the add-on cover 17, as illustrated in FIGS. 1-7, is shown to be circular in shape, having a dome upper face and a flat lower face. So that the user can see the timepiece face and the decorative item, the add-on cover is made of a transparent material. Examples of possible transparent materials include, but are not limited to, glass and plastic.

As shown in FIG. 5, the add-on cover includes a circular cavity 22. While FIG. 5 illustrates the use of a circular cavity, the cavity need not be limited to a circular shape. Other shapes would work equally well, including square and rectangular. As previously stated, any type of decorative item may be placed in the cavity. FIGS. 1-5 illustratively show the cavity 22 sized to fit a metal coin. The metal coin is confined, in these figures, by the circular wall of the cavity 22.

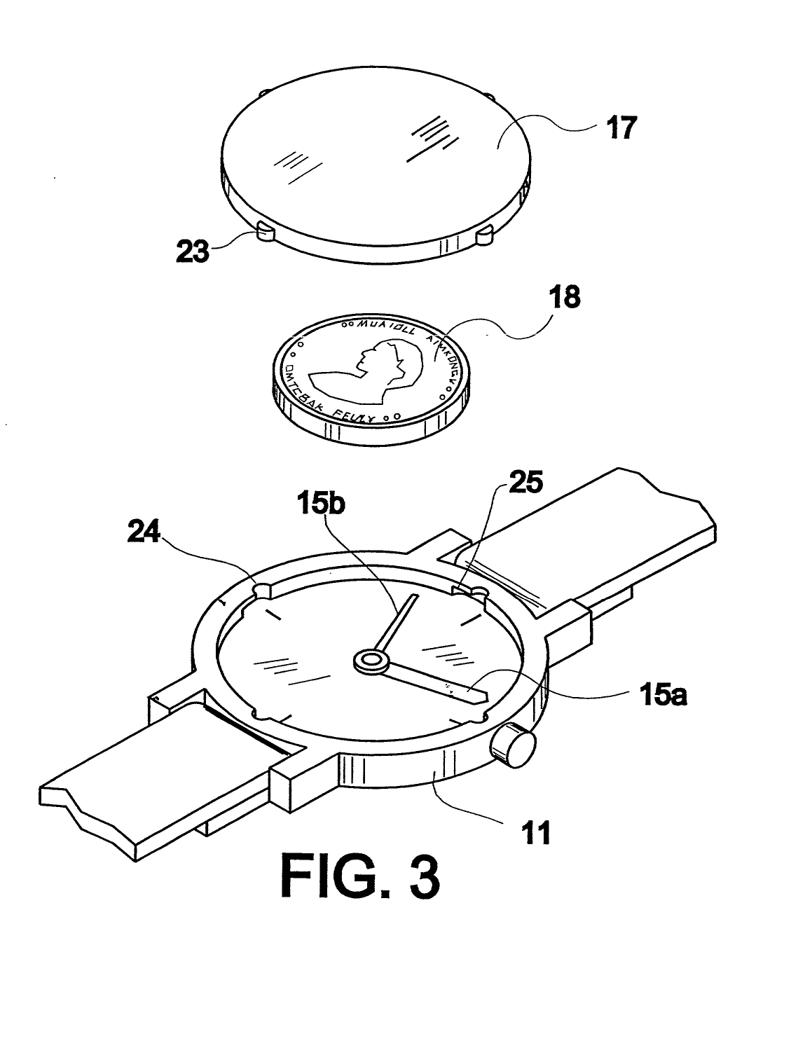

The upper rim 21 of the timepiece casing 11 is projected above the lens 16 to a suitable height so that a portion of the add-on cover 17 is held between the upper rim 21. According to an embodiment of the present invention, as shown in FIG. 3, the add-on cover 17 is secured in position by fitting its four projected lugs 23 into four channels 25 on the inner wall of the upper rim 21. It is contemplated that other means of securing the add-on cover 17 to the case 11 would work equally well, including, but not limited to, snap fittings and small screws. In this embodiment, there are a plurality of small semi-circular lugs 23 projected from the add-on cover 17. These lugs are designed to fit into channels 25 which hold the lugs and in turn hold the add-on cover 17. To attach the add-on cover 17 onto the case 11, the user first locates the projected lugs over the semicircular grooves 24 on the watchcase. The lugs 23 are pushed into the grooves 24 and landed into the channels 25. The user may then manually turn the add-on cover 17 about its center for a small angle so that the lugs 23 go completely into the channels 25 on the case 11. The add-on cover 17 is thus held securely onto the case 11 of the timepiece.

The add-on cover 17 can be taken off the case 11 by reversing the procedure outlined above. The user turns the add-on cover 17 in a direction that disengages the lugs 23 from the channels 25 until the lugs are stopped by the semicircular grooves 24. This frees the locking action of the lugs 23 by the channels 25 and the add-on cover 17 can then be taken off from the case 11.

The length of the hands 15a and 15b, and the diameter of the dial face 14 are made substantially larger than the diameter of the coin 18 such that the time indicated can be viewed without being obstructed by the coin. The shape of the hour indicating hand 15a is made differently to that of the minute indicating hand 15b to allow the user to distinguish the hour indication and the minute indication.

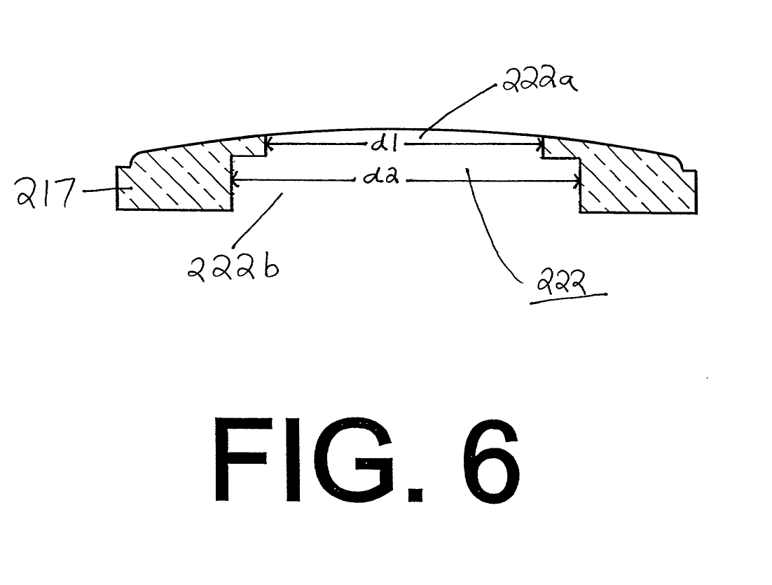

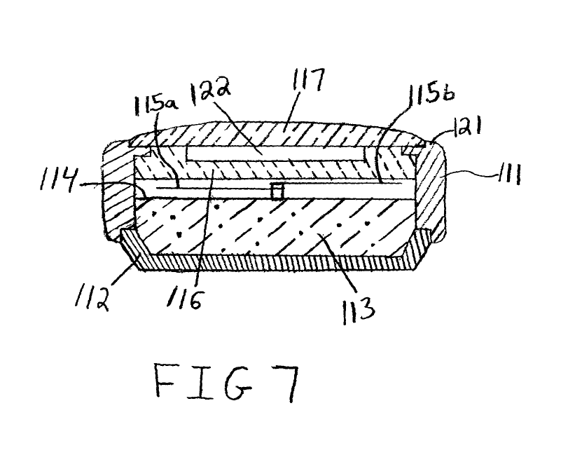

FIG. 6 shows an alternate embodiment of the present invention in which the add-on cover 217 has a cavity 222. The cavity 222 has an upper section 222a and a lower section 222b. Extending the cavity through the top of the add-on cover 217, exposes a portion of any decorative item in the lower section 222b of the cavity 222. The upper section 222a is narrower than the lower section 222b so that the add-on cover 217 can secure any decorative item placed in the lower section 222b of the cavity 222. As illustrated in FIG. 6, the diameter d1 of the upper section 222a is smaller than the diameter of the lower section 222b. As has been previously stated, it is contemplated for all embodiments of the present invention that any shape watch may be used. Thus, it is not necessary that the add-on cover have a spherical shape. That being the case, for add-on covers with non-spherical shapes, the diameters d1 and d2 illustrated in FIG. 6 would be replaced with a length or width, as appropriate.

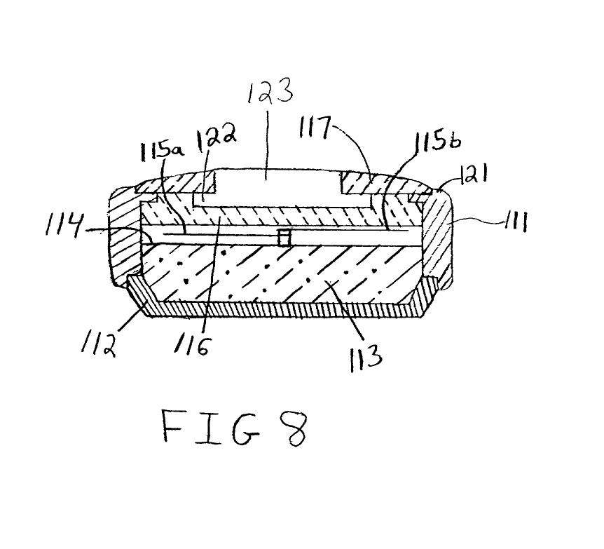

FIG. 7 shows an alternate embodiment of the present invention in which a cavity 122 is formed in the lens 116 instead of the add-on cover 117. According to this embodiment, a decorative item is placed directly in the cavity 122 of the lens 116. The add-on cover 117 is then secured to the case 111 thereby trapping the decorative item in the cavity 122. The decorative item 118 is trapped because the flat lower face of the add-on cover 117 sits on top of the cavity 122 when the add-on cover 117 is secured to the case 111.

FIG. 8 shows another embodiment of the present invention. In this embodiment, the placement of the cavity 122 is identical to that illustrated in FIG. 7, and described above. This embodiment, however, includes an additional cavity 123 formed in the add-on cover 117. The cavity 123 is adjacent to the cavity 122 formed in the lens 116 such that the cavity 123 exposes a portion of any decorative item placed in the cavity 122. The cavity 123 is made narrower than the cavity 122 so that the add-on cover 117 secures the decorative item placed in the cavity 122.

Other embodiments and uses of the present invention will be apparent to those skilled in the art from consideration of this application and practice of the invention disclosed herein. The present description and examples should be considered exemplary only, with the true scope and spirit of the invention being indicated by the following claims. As will be understood by those of ordinary skill in the art, variations and modifications of each of the disclosed embodiments, including combinations thereof, can be made within the scope of this invention as defined by the following claims.

What is claimed is:

1. A timepiece comprising:
a body, wherein the body comprises
a case,
a back cover,
a dial plate,
a lens, and
a horological mechanism, wherein the horological mechanism is located within the body between the back cover and the dial plate;
a shaft operatively connected to the horological mechanism and extending in a substantially perpendicular direction to the dial plate;
at least one hand attached to the shaft and extending in a direction substantially parallel to the dial plate, the at least one hand located within the body between the dial plate and the lens;
an add-on cover, wherein the add-on cover comprises a cavity, and wherein the add-on cover is attachable to the body; and
a securing means for securing the add-on cover to the body.

2. The timepiece of claim 1, wherein the add-on cover is made from a transparent material.

3. The timepiece of claim 1, wherein the add-on cover comprises a plurality of lugs, and wherein the plurality of lugs are used to attach the add-on cover to the body.

4. The timepiece of claim 1, wherein the case comprises an upper rim, and wherein the upper rim is projected above the lens so that the add-on cover is at least partially held within the upper rim.

5. The timepiece of claim 4, wherein the upper rim comprises a plurality of channels.

6. The timepiece of claim 5, wherein the add-on cover comprises a plurality of lugs, and wherein the plurality of lugs are fitted into the plurality of channels thereby attaching the add-on cover to the body.

7. The timepiece of claim 1, wherein the cavity comprises an upper section and a lower section, and wherein the upper section is narrower than the lower section.

8. The timepiece of claim 1, wherein the size of the cavity is such that the at least one hand extends beyond the cavity.

9. The timepiece of claim 1, wherein the at least one hand comprises an hour hand and a minute hand, and wherein the shape of the hour hand is different then the shape of the minute hand so that the hour hand can be distinguished from the minute hand.

10. The timepiece of claim 1, wherein the dial plate is substantially larger than the cavity.

11. The timepiece of claim 1, wherein the cavity comprises a decorative item.

12. The timepiece of claim 11, wherein the decorative item is a coin.

13. The timepiece of claim 1, wherein the add-on cover is spherical in shape and has a dome upper face and a flat lower face.

14. A timepiece comprising
a case;
a back cover;
a dial plate;
a lens;
a horological mechanism, wherein the horological mechanism is located between the back cover and the dial plate;
a shaft operatively connected to the horological mechanism and extending in a substantially perpendicular direction to the dial plate;
at least one hand attached to the shaft and extending in a direction substantially parallel to the dial plate, the at least one hand located between the dial plate and the lens; and
an add-on cover, wherein the add-on cover comprises a bottom face, wherein the bottom face comprises a cavity, wherein the add-on cover is attachable to the case such that at least a portion of the bottom face is adjacent to the lens, wherein the case comprises an upper rim, wherein the upper rim is projected above the lens so that the add-on cover is at least partially located between the upper rim, wherein the upper rim comprises a plurality of channels, wherein the add-on cover comprises a plurality of lugs, and wherein the plurality of lugs are fitted into the plurality of channels thereby attaching the add-on cover to the body.

15. A timepiece comprising:
a body, wherein the body comprises
a case,
a back cover,
a dial plate,
a lens, wherein the lens comprises a first cavity, and
a horological mechanism, wherein the horological mechanism is located within the body between the back cover and the dial plate;
a shaft operatively connected to the horological mechanism and extending in a substantially perpendicular direction to the dial plate;
at least one hand attached to the shaft and extending in a direction substantially parallel to the dial plate, the at least on hand located within the body between the dial plate and the lens; and
an add-on cover, wherein the add-on cover is attachable to the body such that at least a portion of the add-on cover is adjacent to the lens.

16. The timepiece of claim 15, wherein the add-on cover is made from a transparent material.

17. The timepiece of claim 15, wherein the add-on cover comprises a plurality of lugs, and wherein the plurality of lugs are used to attach the add-on cover to the body.

18. The timepiece of claim 15, wherein the case comprises an upper rim, and wherein the upper rim is projected above the lens so that the add-on cover is at least partially located within the upper rim.

19. The timepiece of claim 18, wherein the upper rim comprises a plurality of channels.

20. The timepiece of claim 19, wherein the add-on cover comprises a plurality of lugs, and wherein the plurality of lugs are fitted into the plurality of channels thereby attaching the add-on cover to the body.

21. The timepiece of claim 15, further comprising a securing means for attaching the add-on cover to the body.

22. The timepiece of claim 15, wherein the size of the first cavity is chosen such that the at least one hand extends beyond the first cavity.

23. The timepiece of claim 15, wherein the at least one hand comprises an hour hand and a minute hand, and wherein the shape of the hour hand is different than the shape of the minute hand so that the hour hand can be distinguished from the minute hand.

24. The timepiece of claim 15, wherein the first cavity comprises a decorative item.

25. The timepiece of claim 24, wherein the decorative item is a coin.

26. The timepiece of claim 15, wherein the add-on cover is spherical in shape and has a dome upper face and a flat lower face.

27. The timepiece of claim 15, wherein the add-on cover comprises a second cavity, and wherein the first cavity is narrower than the second cavity.
